(19) United States
(12) Patent Application Publication
(10) Pub. No.: US 2025/0265626 A1
(43) Pub. Date: Aug. 21, 2025

(54) ITINERARY SEARCH BASED ON IMAGE DATA

(71) Applicant: KAYAK Software Corporation, Stamford, CT (US)

(72) Inventors: Jacob Vincent Bouvrie, Arlington, MA (US); Girish Naik, Abington, MA (US)

(21) Appl. No.: 18/581,603

(22) Filed: Feb. 20, 2024

(51) Int. Cl. G06Q 30/0601; G06F 16/532; G06Q 10/02

(52) U.S. Cl. CPC G06Q 30/0629; G06F 16/532; G06Q 10/02; G06Q 30/0631

(57) ABSTRACT

An example method includes receiving image data representing a screenshot of an itinerary, generating one or more query attributes based in part on the screenshot, and transmitting one or more requests for travel data that satisfy the one or more query attributes. The method may also include receiving, at a first time and in response to the one or more requests, a first portion of travel data that satisfies the one or more query attributes. The method further includes generating a primary itinerary recommendation comprising a first set of one or more itineraries that satisfy the one or more query attributes and transmitting the primary itinerary recommendation to a client device for presentation. The method further includes receiving a second portion of travel data may be received at a second time, generating a secondary itinerary recommendation, and transmitting the secondary itinerary recommendation to the client device for presentation.

### BACKGROUND

Individuals interested in booking flights, hotel, and/or a rental car often visit multiple travel sites to compare prices and travel options. Once an individual finds an itinerary that he or she is interested in purchasing, there is no way to determine if the itinerary is the best option without reinputting travel information (e.g., departure location, departure date, return date, etc.) into one or more search tools. Manually reinputting the same information into one or more search tools can be a time-consuming and tedious process. Current search systems do not provide a means for individuals to efficiently search for and compare travel reservation data.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a schematic view of an example system usable to search for travel data based at least in part on received image data, in accordance with an example of the present disclosure.

FIGS. 2A-2F illustrate example user interfaces that are usable to upload image data and present search results for travel data, in accordance with examples of the present disclosure.

FIG. 3 illustrates a sequence diagram of an example process for generating search results for travel data using image data, in accordance with examples of the present disclosure.

FIG. 4 is a flow diagram of an example process for generating itinerary recommendation(s) based in part on receiving a screenshot of an itinerary, in accordance with examples of the present disclosure.

FIG. 5 is a flow diagram of an example process for the generation and training of artificial intelligence models to perform one or more of the processes described herein, in accordance with examples of the present disclosure.

FIG. 6 illustrates an example system and device that is usable to implement the techniques described herein.

### DETAILED DESCRIPTION

As discussed above, when an individual (or user) is planning to travel, the individual may visit multiple websites or applications to find the lowest airfare or ideal route. Once the individual finds an itinerary the individual is interested in purchasing, there is no way to compare the itinerary with other itineraries (or to search for other itineraries) without having to reinput the same travel information (e.g., travel dates, departure location, destination, airline, etc.) into a travel search tool or website. Reinputting the same information into multiple search tools can be time-consuming and tedious. Additionally, in the case where a user finds an itinerary or travel destination that another user captured (e.g., an itinerary another user posted on a blog page, social media site, an itinerary received in a text message or email, etc.), there is no way for the user to quickly search for travel options using the image. Current systems do not provide the user a means to search for comparable itineraries, customized for the user, utilizing an image of an itinerary or a travel destination (e.g., image of the Eiffel tower, Colosseum, a beach, etc.).

The present disclosure describes techniques for searching for travel data (e.g., flights, hotels, car rentals, etc.) using an image. The image may be a screenshot captured on a user computing device (e.g., a mobile device, tablet, desktop computer, etc.), an image captured using a camera, and the like. A data processing system, such as a travel metasearch engine and a travel booking platform, may receive and process the image data such that a search for travel data may be performed. In some examples, a data processing system can access multiple travel reservation databases of suppliers in many countries. Suppliers may be referred to as companies or travel service providers, such as airlines, trains, buses, cruise lines, hotels, rental car companies, and the like. In some examples, suppliers can provide accommodation services and/or transportation services to customers.

The data processing system may use the provided image data to generate one or more query attributes. The query attributes may include values that define one or more conditions or criteria for results to be returned by the data processing system and/or travel service provider system(s). A query attribute (or parameter) may include, for example, destination information (e.g., departure city or airport, arrival city or airport, multiple destinations in the case of a multi-city itinerary, particular location or landmarks within a destination), travel dates (e.g., departure date, return date, flexible date options or ranges, days of the weeks, etc.), a desired length of stay at a destination, number of travelers (e.g., number of adults and/or children, ages of children, infants, etc.) travel class (e.g., economy, business, first class), seating preferences (e.g., aisle seat, window seat, etc.), flight preferences (e.g., direct flight, layover preferences, etc.), pricing (e.g., a maximum budget for a flight, hotel, and/or preferences for a low-cost carrier), accommodation preferences (e.g., hotel, vacation rental, a preferred rating of the hotel, number of rooms or beds, particular hotel chains, etc.), transportation (e.g., rental car preferences, public transit options, airport transfers, etc.), activities and/or attractions (e.g., beach, hiking, mountains, etc.), recreational interests (e.g., golf, spa, etc.), meal preferences (e.g., all-inclusive, breakfast included, etc.), and the like.

The data processing system may send one or more requests to travel service provider system(s) for travel data that satisfies one or more of the query attributes. The travel data (e.g., an itinerary, plane tickets, hotel bookings, car rental information, etc.) may be received from the travel service provider system(s) at various times. The data processing system may transmit the travel data to a user computing device for presentation via a user interface. In some examples, the data processing system may generate itinerary recommendations for the user based at least in part on preference data associated with the user and transmit the recommendations to the user computing device for presentation. These and other examples are discussed in further detail below.

The present disclosure provides an overall understanding of the principles of the structure, function, manufacture, and use of the systems and methods disclosed herein. One or more examples of the present disclosure are illustrated in the accompanying drawings. Those of ordinary skill in the art will understand that the systems and methods specifically described herein and illustrated in the accompanying drawings are non-limiting embodiments. The features illustrated or described in connection with one embodiment may be combined with the features of other embodiments, including as between systems and methods. Such modifications and variations are intended to be included within the scope of the appended claims.

Additional details are described below with reference to several example embodiments.

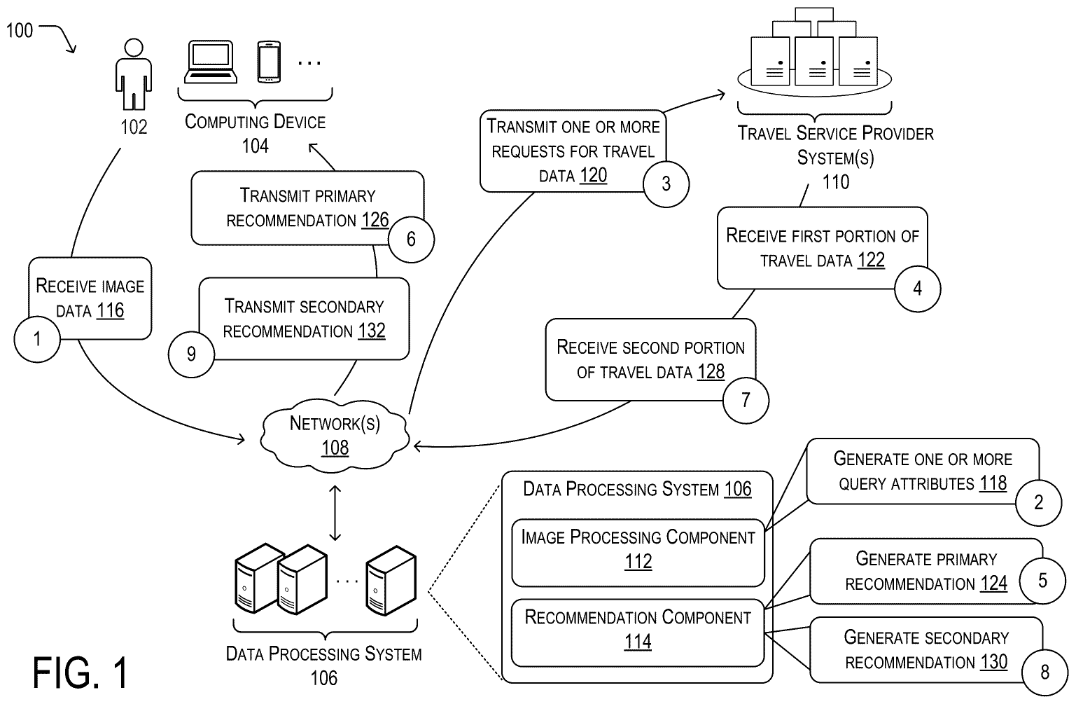

FIG. 1 is a schematic view of an example system 100 usable to search for travel data based at least in part on received image data. In some examples, the system 100 may include a user 102 (or client, customer, etc.) that interacts with the data processing system 106 using a computing device 104 via a network 108. The computing device 104 may include desktop computers, laptop computers, tablet computers, mobile devices (e.g., smart phones or other cellular or mobile devices, gaming devices, portable media devices, etc.) or other suitable computing devices. The computing device 104 may execute one or more client applications, such as a web browser (e.g., Microsoft Windows Internet Explorer®, Mozilla Firefox®, Google Chrome®, etc.) and/or a native or special-purpose client application (e.g., travel search site applications, social media applications, messaging applications, etc.) to access and view content over the network 108. The computing device 104 may connect to the data processing system 106 through the use of a web browser or custom application to send and/or receive data from the data processing system 106.

The network 108 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which the computing device 104 may access the data processing system 106 and/or communicate with one another.

The data processing system 106 may include one or more servers or other computing devices, any or all of which may include one or more processors and memory storing computer executable instructions to implement the functionality discussed herein attributable to the data processing system 106 or digital platform. The data processing system may enable a user 102 (such as a person or an organization) to interact with the data processing system 106. The data processing system 106 may, with input from a user, create and store in the data processing system 106 a user account or user profile associated with the user.

The data processing system 106 may be a travel metasearch engine and a booking platform that provides a range of services related to travel planning and booking reservations. In some examples, the data processing system 106 may be associated with a travel metasearch engine that aggregates and compares travel-related information, such as flights, hotels, rental cars, vacation packages, etc. from various sources. The data processing system 106 may be configured to receive image data from the computing device 104, process the image data to generate one or more query attributes and their associated values, generate and transmit one or requests to one or more of the travel service providers system(s) 110 for travel data, and send the travel data to the computing device 104 to be presented. The data processing system 106 may receive the image data in conjunction with a request to perform a travel search (e.g., a query).

For example, at operation 116 (indicated by “1”), the data processing system 106 may receive, from the computing device 104 (or client device), a request to perform a query (or travel search). In some examples, the query request (or search request) may comprise image data. The image data may be a screenshot captured on a mobile device, a downloaded image, an image shared on a social media platform, a snippet or screenshot of an image captured on a desktop computer, laptop, tablet, etc. In some examples, a user may copy and paste an image or drag-and-drop an image into an interactive box associated with the data processing system. The image may be in a JPEG format, PNG format, GIF format, etc. In some examples, the image may be a screenshot of an itinerary. The itinerary may include textual information about a travel destination and may include details such as travel dates, flight or transportation information, hotel reservations, and/or any other relevant travel data. In some examples, the image may be of a popular destination and/or may include a famous landmark, such as the Eiffel tower, Colosseum, Lincoln Memorial, etc. In some examples, the image may include a recreation or theme, such as a beach vacation, ski resort, a theme park, etc. In some examples, the query request may comprise multiple images. That is, a user may upload multiple images to provide additional context and/or in order to receive a more personalized search result. In some examples, in additional to the image data, a user may provide one or more search criteria for a travel reservation (e.g., by indicating a number of passengers, a preferred airline, travel dates, etc.) in order to generate a more pertinent and personalized search result.

In some examples, in response to receiving image data in association with a request to perform a travel search, the image processing component 112 may validate and/or sanitize the metadata associated with the image to ensure it is not a potential injection attack (or other type of cybersecurity attack in which malicious code or unauthorized commands may be inserted). For example, the image processing component 112 may validate and/or sanitize metadata associated with the image data to ensure the image data does not contain malicious code and/or unexpected input. In some examples, the image processing component 112 may verify that the uploaded image data is associated with the expected content type (e.g., image/jpeg, image/png) and/or it is in a proper format (e.g., JPEG, PNG, etc.). In some examples, the image processing component 112 may automatically reject any image data that does not meet the criteria (e.g., size criteria, format criteria, etc.). In some examples, the image processing component 112 may enforce a limit on a size of the image data to prevent excessively large or resource-intensive images from being processed.

At operation 118 (indicated by “2”), an image processing component 112 associated with the data processing system 106 may process the image data and generate one or more query attributes. Query attributes (or parameters) may include, for example, destination information (e.g., departure city or airport, arrival city or airport, multiple destinations in the case of a multi-city itinerary, particular location or landmarks within a destination), travel dates (e.g., departure date, return date, flexible date options or ranges, days of the weeks, etc.), a desired length of stay at a destination, number of travelers (e.g., number of adults and/or children, ages of children, infants, etc.) travel class (e.g., economy, business, first class), seating preferences (e.g., aisle, window, etc.), flight preferences (e.g., non-stop flight, direct flight, layover preferences, etc.), pricing (e.g., a maximum budge for a flight, hotel, and/or preferences for a low-cost carrier), accommodation preferences (e.g., hotel, vacation rental, a preferred rating of the hotel, number of rooms or beds, particular hotel chains, etc.), transportation (e.g., rental car preferences, public transit options, airport transfers, etc.), activities or attractions (e.g., beach, hiking, mountains, etc.), recreational interests (e.g., golf, spa, etc.), meal preferences (e.g., all-inclusive, breakfast included, etc.), and the like.

Query attributes may be used when generating and transmitting one or more web resource requests for travel data. In some examples, the query attributes may include values that define one or more conditions or criteria for results to be returned by the data processing system 106 and/or travel service provider system(s) 110. In some examples, in addition to the image, a user may provide one or more parameters and/or preferences. That is, in addition to the image data, a user may provide additional information the user is interested in searching. For example, a user may upload an image of a beach and input (e.g., using a touch screen, keyboard, etc.) additional information such as a departure city, a departure airport, a departure date, preferred airline, number of passengers, etc. The data processing system may then provide search results and/or recommendations for travel destinations that match the theme of the provided image as well as the additional information the user provided.

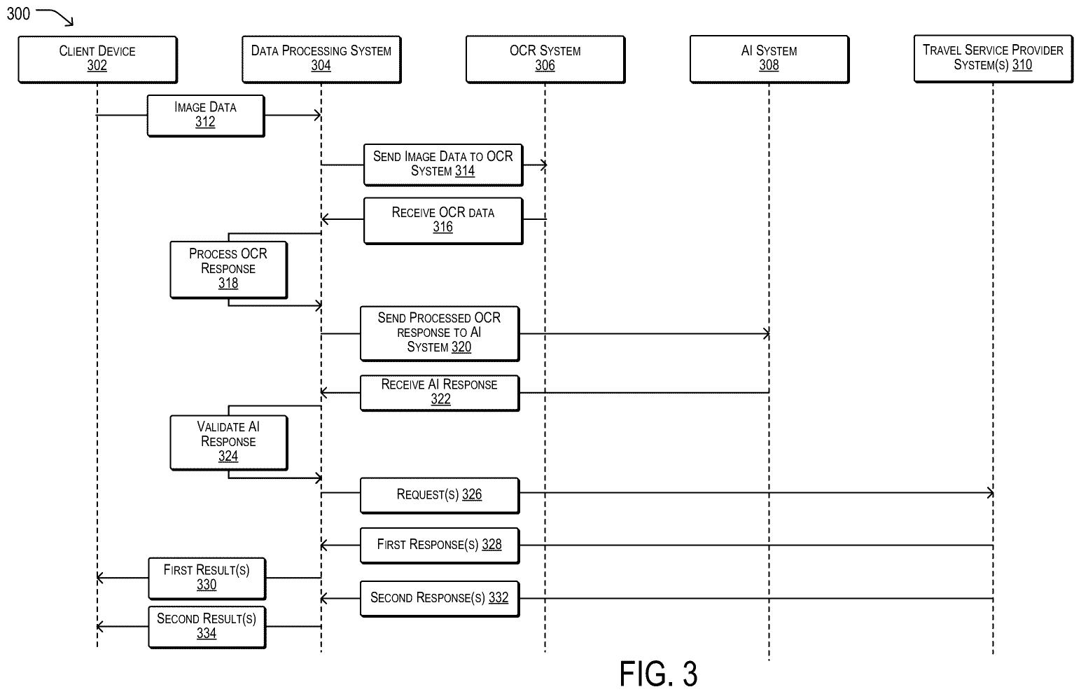

In some examples, to generate one or more query attributes, the image processing component 112 may perform optical character recognition (OCR) on the image to extract text and convert it into a machine-readable form. In some examples, prior to performing OCR, the image processing component 112 may perform a preprocessing technique on the image data to enhance the quality of the image and prepare it for OCR. Preprocessing techniques may include correcting any rotation, tilts, or skews in the image, removing unnecessary borders or margins, filtering out background noise or artifacts, converting the image to a black and white image (i.e., grayscale), resizing the image, and the like. In some examples, in the case where characters are not separated clearly, a character segmentation technique may be performed to divide text into distinct characters for recognition. In some examples, feature extraction is performed on the image data to identity shape, spatial relationships, etc. In some examples, machine learning techniques (e.g., machine learning models, neural networks, pattern recognition techniques, large language models, and the like) may be used to identify characters in the image. In some examples, after performing OCR, the image processing component 112 may correct error(s) and/or improve accuracy of the recognized text (e.g., by spellchecking the recognized text, correcting grammatical errors in the recognized text, and the like). Further details related to generating one or more query attributes are provided below in the description of FIG. 3.

In some examples, the data processing system 106 may include and/or be associated with one more machine learning model(s) that are configured to receive, as input, image data, and output one or more query attributes in a structured data format (e.g., JavaScript Object Notation (JSON) format, Extensive Markup Language (XML), Concise Binary Object Representation (CBOR), and the like). In some examples, the data processing system 304 may input an image into a pre-trained image processing model (such as a convolutional neural network or CNN) that is configured to analyze the image and extract relevant features or information. These features can include object detection (e.g., famous landmarks), image classification (e.g., an itinerary, a rental car receipt, hotel receipt, etc.), text recognition (OCR), or any other relevant information found within the image. In some examples, a machine learning model may be configured to detect an origin channel (e.g., application, website, etc.) of a screenshot based at least in part on the user interface or user interface elements detected in the screenshot. The extracted information may then be structured into a particular format, such as a JSON format. A JSON is a lightweight data interchange format used for structuring and transmitting data between a server and a client, between different parts of an application, or for data storage. In JSON objects, data is organized as key-value pairs, where keys are strings and values can be any valid JSON data type.

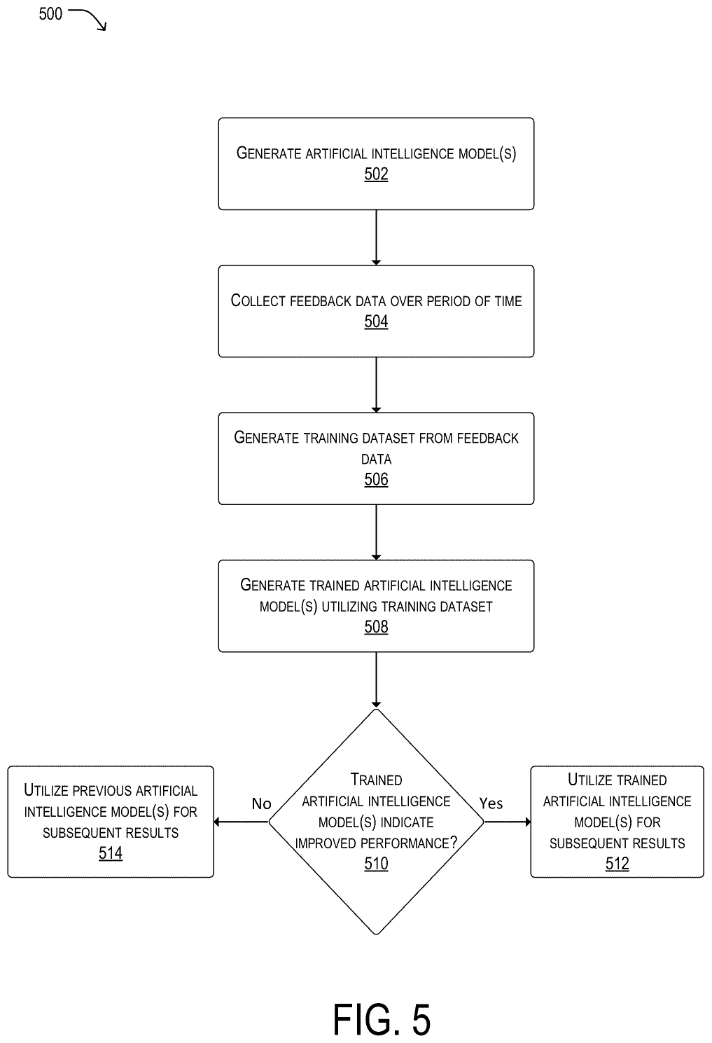

Additional details regarding artificial intelligence and machine learning models are provided below with respect to FIGS. 3 and 5.

In still other examples, the image data may be processed utilizing computer vision techniques to identify objects in the image data and/or attributes of those objects. For example, with respect to computer vision techniques, computer vision includes methods for acquiring, processing, analyzing, and understanding images and, in general, high-dimensional data from the real world in order to produce numerical or symbolic information, e.g., in the form of decisions. Computer vision seeks to duplicate the abilities of human vision by electronically perceiving and understanding an image. Understanding in this context means the transformation of visual images (the input of the retina) into descriptions of the world that can interface with other thought processes and elicit appropriate action. This image understanding can be seen as the disentangling of symbolic information from image data using models constructed with the aid of geometry, physics, statistics, and learning theory. Computer vision has also been described as the enterprise of automating and integrating a wide range of processes and representations for vision perception. As a scientific discipline, computer vision is concerned with the theory behind artificial systems that extract information from images. The image data can take many forms, such as video sequences, views from multiple cameras, or multi-dimensional data from a scanner. As a technological discipline, computer vision seeks to apply its theories and models for the construction of computer vision systems

One aspect of computer vision comprises determining whether or not the image data contains some specific object, feature, or activity. Different varieties of computer vision recognition include: Object Recognition (also called object classification)—One or several pre-specified or learned objects or object classes can be recognized, usually together with their 2D positions in the image or 3D poses in the scene. Identification—An individual instance of an object is recognized. Examples include identification of a specific person's face or fingerprint, identification of handwritten digits, or identification of a specific vehicle. Detection—The image data are scanned for a specific condition. Detection based on relatively simple and fast computations is sometimes used for finding smaller regions of interesting image data that can be further analyzed by more computationally demanding techniques to produce a correct interpretation.

Several specialized tasks based on computer vision recognition exist, such as: Optical Character Recognition (OCR)—Identifying characters in images of printed or handwritten text, usually with a view to encoding the text in a format more amenable to editing or indexing (e.g., ASCII). 2D Code Reading—Reading of 2D codes such as data matrix and QR codes. Facial Recognition. Shape Recognition Technology (SRT)—Differentiating human beings (e.g., head and shoulder patterns) from objects.

Some functions and components (e.g., hardware) found in many computer vision systems are described here. For example, a digital image is produced by one or several image sensors, which, besides various types of light-sensitive cameras, may include range sensors, tomography devices, radar, ultra-sonic cameras, etc. Depending on the type of sensor, the resulting image data may be a 2D image, a 3D volume, or an image sequence. The pixel values may correspond to light intensity in one or several spectral bands (gray images or color images), but can also be related to various physical measures, such as depth, absorption or reflectance of sonic or electromagnetic waves, or nuclear magnetic resonance. Before a computer vision method can be applied to image data in order to extract some specific piece of information, it is usually beneficial to process the data in order to assure that it satisfies certain assumptions implied by the method. Examples of pre-processing include, but are not limited to re-sampling in order to assure that the image coordinate system is correct, noise reduction in order to assure that sensor noise does not introduce false information, contrast enhancement to assure that relevant information can be detected, and scale space representation to enhance image structures at locally appropriate scales. Image features at various levels of complexity are extracted from the image data. Typical examples of such features are: Lines, edges, and ridges; Localized interest points such as corners, blobs, or points; More complex features may be related to texture, shape, or motion. At some point in the processing a decision may be made about which image points or regions of the image are relevant for further processing. Examples are: Selection of a specific set of interest points; Segmentation of one or multiple image regions that contain a specific object of interest; Segmentation of the image into nested scene architecture comprising foreground, object groups, single objects, or salient object parts (also referred to as spatial-taxon scene hierarchy). At this point, the input may be a small set of data, for example a set of points or an image region that is assumed to contain a specific object. The remaining processing may comprise, for example: verification that the data satisfy model-based and application-specific assumptions; estimation of application-specific parameters, such as object pose or object size; classifying a detected object into different categories; and comparing and combining two different views of the same object. Making the final decision required for the application, for example match/no-match in recognition applications, may then be performed.

In some examples, the data processing system 106 may determine that insufficient information was detected and/or extracted from the image data. For example, the image may be of poor quality, a portion of the information in the image may be cutoff, the image may be missing a key piece of travel data (or key query attribute), such as a departure city, date range, destination airport, etc. In some examples, the data processing system 106 may access a user account or user profile associated with the user 102 and/or computing device 104 and use the information the user provided to personalize a travel search and/or fill in the missing information that was not found in the image. For example, the image processing component 112 may determine the image is missing a departure city. The data processing system 106 may determine a departure city (i.e., fill in the missing information) based at least in part on accessing one or more of a user profile associated with the computing device 104 (e.g., the user may provide an address and/or departure city when creating a user profile), accessing a database to determine prior search history for the user where the user input a departure city (e.g., while using the data processing system), determining geotagging and metadata associated with the image (e.g., by extracting location information from a geotagged image), GPS data associated with the user computing device 104, and the like. In some examples, the data processing system 106 may access user preferences associated with a user profile, saved searched, previous booking history stored in association with the user profile, in additional to the provided image data to provide personalized recommendations and search results.

In some examples, based at least in part on determining the image data is missing one or more search parameters (or query attributes), the data processing system 106 may present a user with an instruction (e.g., via a pop-up window) to provide additional information and/or to upload an additional image. In some examples, based at least in part on determining the image data is missing one or more query attributes, the data processing system 106 may generate default one or more query attributes to use when searching for travel data. For example, if the image processing component 112 determines the image data does not indicate a number of passengers, the data processing system 106 may generate a default query attribute representing a single passenger (e.g., “passengerCount”: 1).

In some examples, the provided image data (e.g., an uploaded itinerary) may be missing information or other data (e.g., flight numbers, number of stops, departure time and/or arrival time, duration of the flight, airline details, seat assignments, price, etc.). A machine learning model may be configured to infer and predict at least a portion of the missing flight data such that a travel search can be performed. In some examples, a machine learning model may be configured to utilize a similarity metric (e.g., k-Nearest Neighbors (KNN) classification or regression) and/or logic tree that weights flight data based at least in part on relevance and/or degree of importance. That is, when an exact match is not possible or when the provided image data is determined to be missing flight information, a machine learned model may be utilized to extract attributes from the image data and weight the attributes based on a similarity metric and utilize the attributes when searching for travel data (e.g., itineraries).

At operation 120 (indicated by “3”) the data processing system 106 transmits one or more requests for travel data that satisfy one or more query attributes. The data processing system 106 may use the generated query attributes and their associated values to generate one or more requests for travel data. In some examples, transmitting one or more requests for travel data can be a call to an application programming interface (API) of a travel service provider system(s) 110. Individual travel service provider systems 110 process the received requests and return one or more responses with travel data that satisfies the query. In some examples, the travel data may be “live travel data” that represents current, real time, or near real time information for a travel related product or service. For example, in the context of flights, live travel data can include flight information that is subject to change over time, such as flight price, flight provider, and/or availability (e.g., number of seats), as well as other flight-related information including departure airport, destination airport, departure date/time, arrival date/time, flight number, and the like. In some examples, the data processing system 106 may additionally or alternatively send a request to retrieve data from one or more database(s) (e.g., a database configured to aggregate and process flight data from multiple sources). In some examples, the data processing system 106 may query a schedule of travel reservations, such as those provided by Innovata™ or Cirium™, based on the query attributes or other criteria included in the query.

Due to factors such as processing delay, propagation delay, database load and server capacity, geographic location, etc. it may take a non-negligible amount of time for the data processing system 106 to receive responses with the requested travel data. To improve the speed with which query results are provided to a user, the data processing system 106 may transmit the responses to the requested travel data to the computing device 104 for presentation as they are received. In some examples, the data processing system 106 may transmit portions of travel data (e.g., in the form of multiple itinerary recommendations) for presentation at the computing device 104 at predetermined time intervals. In some examples, in addition to, or alternative to sending one or more requests to travel service provider system(s) 110, the data processing system 106 may send a query to a database for cached travel data.

For example, at operation 122 (indicated by “4”) the data processing system receives, in response to the one or more requests and at a first time, a first portion of travel data that satisfy the one or more query attributes. The first portion of travel data may represent an initial set of responses received from the travel service provider system(s) 110. In some examples, the first portion of travel data may represent a first threshold number of responses that were received. In some examples, the threshold number of responses may depend on a quality of confidence score associated with the received response. In some examples, the first portion of travel data may be travel data that was received after a threshold period of time (e.g., 5 seconds, 7 seconds, etc.).

At operation 124 (indicated by “5”), a recommendation component 114 associated with the data processing system 106 may process the received first portion of travel data and generate a primary itinerary recommendation. The primary itinerary recommendation may comprise a first set of one or more itineraries that satisfy the one or more query attributes. In some examples, the primary itinerary recommendation may comprise one or itineraries that satisfy a greater number of query attributes (as compared to the secondary itinerary recommendations). In at least one example, the primary itinerary recommendation may comprise a single itinerary that represents an itinerary the user may be most interested in purchasing.

At operation 126 (indicated by “6”), the data processing system 106 transmits the primary itinerary recommendation to the computing device 104 for presentation via a user interface. That is, while responses to others of the one or more requests for travel data are still being received, the primary itinerary recommendation may be transmitted for presentation. The primary itinerary recommendation may be presented using any variety of graphical and/or textual representations (e.g., via a browser or dedicated application). The one or more itineraries in the primary itinerary recommendation may be actionable such that selection of a result (or a user interface element associated with a result) navigates the user to an interface for booking the flight with the provider.

At operation 128 (indicated by “7”), the data processing system receives, in response to the one or more requests and a second time after the first time, a second portion of travel data that satisfy the one or more query attributes. The second portion of travel data may represent a second set of responses (or results) received from the travel service provider system(s) 110. In some examples, the second portion of travel data may represent a threshold number of responses that were received. In some examples, the threshold number of responses may depend on a quality or confidence score associated with the received response. In some examples, the second portion of travel data may be travel data that was received after a threshold period of time. In some examples, the data processing system 106 may determine that a threshold period of time (e.g., 10 seconds, 15 seconds, 20 seconds, etc.) has passed since transmitting the one or more requests for travel data. In response to determining that the threshold period of time has passed, the data processing system may cause a server associated with the data processing system 106 to stop receiving travel data responses from the travel service provider system(s) 110.

At operation 130 (indicated by “8”), the recommendation component 114 associated with the data processing system 106 may process the received second portion of travel data and generate a secondary itinerary recommendation different than the primary itinerary recommendation. In some examples, the secondary itinerary recommendation may comprise alternative itinerary options that the user may be interested in. The secondary itinerary recommendation may comprise a second set of one or more itineraries that satisfy the one or more query attributes. In some examples, the second itinerary recommendation may comprise one or itineraries that satisfy a different number of query attributes and/or a lesser number of query attributes as compared to one or more itineraries in the primary itinerary recommendation. In at least one example, the second set of one or more itineraries may be alternative itinerary options that may be desirable to the user based on one or more preferences associated with the user profile and/or prior search history. Although the present disclosure describes generating a primary itinerary recommendation and a secondary itinerary recommendation, it is contemplated that fewer or additional itinerary recommendations may be generated (e.g., a tertiary recommendation, etc.).

In some examples, the data processing system may weight the one or more query attributes or parameters based at least in part on a preference associated with one or more users. For example, some users may prioritize cost-saving options and prefer flights that are the least expensive, while other users may prioritize short layovers to minimize travel time over cost savings, while still others may prioritize direct flights and avoid layovers altogether over cost savings. The data processing system may generate the primary itinerary recommendation and the secondary itinerary recommendation based at least in part on the weighting so that results that relate to preferences of a user are presented and/or ranked higher on a list of itinerary recommendation. In some examples, the data processing system may weight the one or more query attributes based at least in part on the travel data that has been received from the travel service provider system(s).

In some examples, the recommendation component may generate the primary itinerary recommendation and the secondary itinerary recommendation using one or more machine learning models. For example, the image data, the first portion of travel data, the second portion of travel data, user data (e.g., user preference data, user account data, user search data, etc.), historical search data, etc. may be input into a machine learning model configured to receive the image data, the first portion of travel data, the second portion of travel data, user data, and/or historical data as input and generate the primary itinerary recommendation and the secondary itinerary recommendation as output. In some examples, a machine learning model may be utilized to infer or fill in data that is missing from the image data and/or travel data. In some examples, historical search data may indicate that a particular search result or type of search result(s) received more interaction (e.g., clicks) from users and this historical search data may be utilized during generation of the primary and/or secondary itinerary recommendations.

At operation 132 (indicated by “9”), the data processing system 106 transmits the secondary itinerary recommendation to the computing device 104 for presentation via a user interface. The secondary itinerary recommendation may be presented using any variety of graphical and/or textual representations. The itineraries may be actionable such that selection of a result (or a user interface element associated with a result) navigates the user to an interface for booking the flight with the provider. In some examples, the primary recommendation may be updated based at least in part in the secondary recommendation.

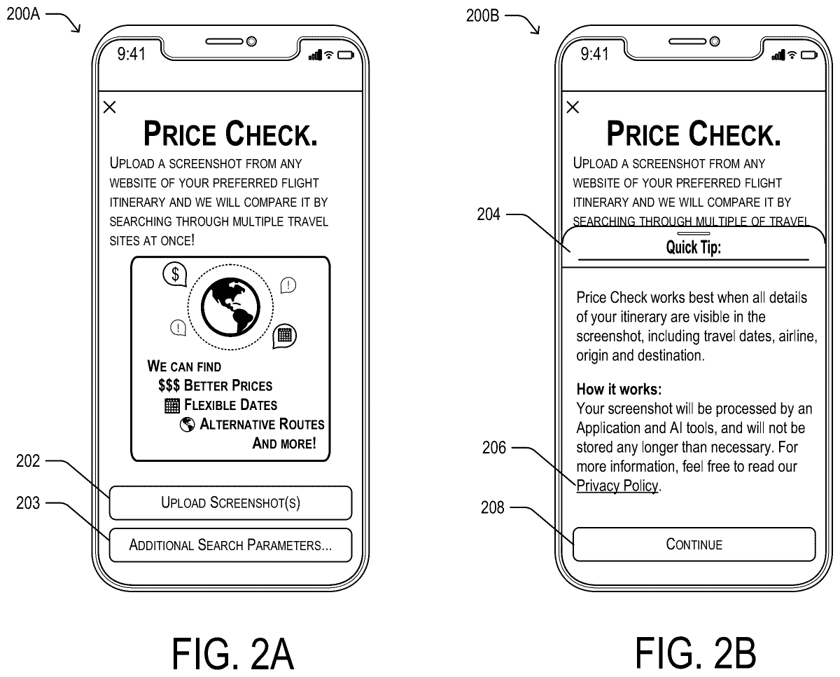

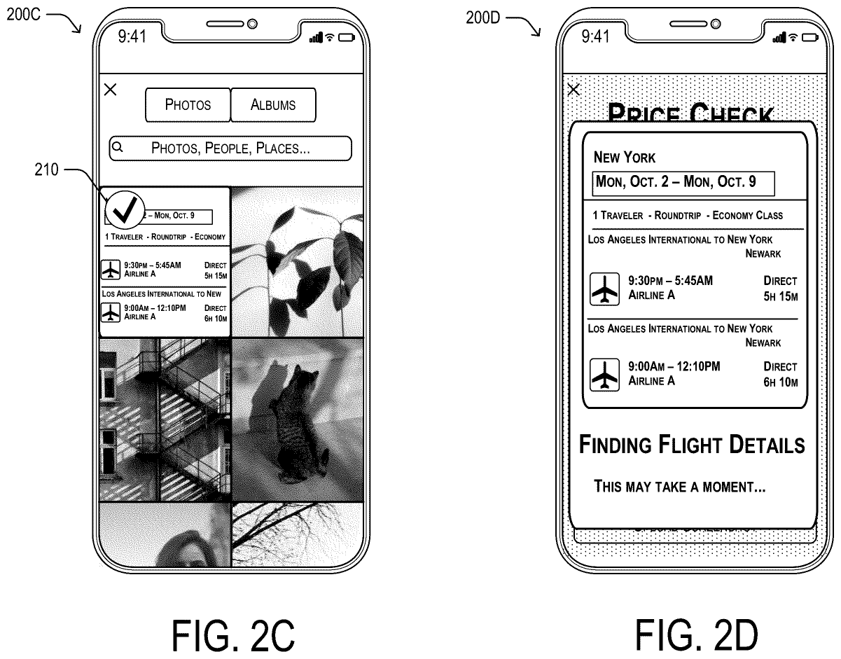

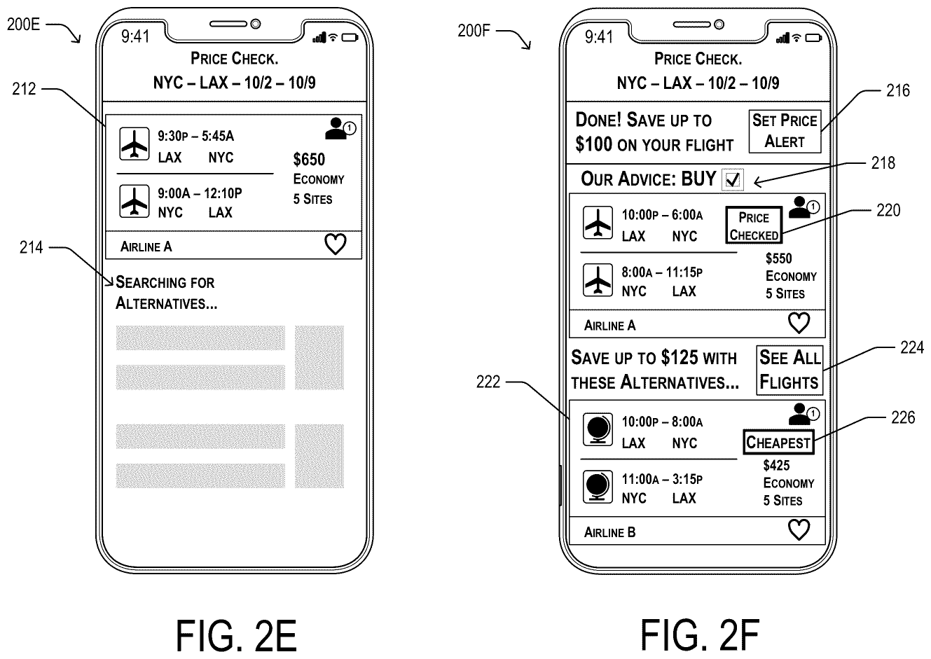

FIGS. 2A-2F illustrate example user interfaces that are usable to upload image data and present search results for travel data, in accordance with examples of the present disclosure. For example, as shown in FIG. 2A, a user may access an application associated with the data processing system. The application can be presented via a user interface 200A associated with the computing device. The application can provide the user interface 200A with instructions for presentation of information such that a user can interact with the application to submit a search query. For example, to initiate a search request using a screenshot, a user may select an “upload screenshot(s)” selectable control 202 presented via the user interface 200A. In some examples a user may additionally provide one or more search parameters (or travel parameters) in addition to the uploaded screenshot by selecting an “additional search parameters . . . ” selectable control 203. For example, a user may upload a screenshot of a landmark (e.g., Statue of Liberty, Great Wall of China, The Great Sphinx, etc.) or an image of a vacation theme, such as a beach, a canyon, a ski resort, etc. As these types of screenshots do not include travel data information, the user may provide one or more search parameters such as a departure city, date ranges (e.g., departure date and/or arrival date), number of passengers, etc. in order to receive more relevant search results. In some examples, the data processing system 106 may perform a search utilizing one or more search parameters the user previously provided (e.g., from prior searches) or one or more search parameters that may be associated with the user profile, etc.

As shown in FIG. 2B, responsive to receiving a selection of the “upload screenshot(s)” selectable control 202, the data processing system may cause a modal 204 (or modal dialog) to be presented via the user interface 200B. In some examples, the modal 204 may be presented to a user upon uploading their first screenshot via the application. The modal may alert the user that the price check works best when all details of the itinerary are visible in the screenshot, including travel dates, airline, origin, and destination. The model may also explain that the uploaded screenshot will be processed by the application associated with the data processing system as well as AI tools. The model may include a link 206 to a privacy policy. A user may select a “continue” selectable control 208 to close or dismiss the modal. In response to receiving a selection of the “continue” selectable control 208, the data processing system may present user interface 200C, as shown in FIG. 2C.

FIG. 2C illustrates a user selection of a screenshot 210 of an itinerary from a camera roll associated with the computing device. In some examples, the data processing system may request permission to access a camera roll associated with the computing device. In some examples, the data processing system may send a system-level permission request to the computing device's operating system (e.g., iOS, Android, etc.) using a platform-specific API. The operating system may display a permission dialog asking the user to grant or deny the data processing system access to the camera roll. After obtaining permission, the data processing system may then cause the user interface to present a camera roll from which the user may select one or more screenshots.

In response to receiving a selection of one or more screenshots, the data processing system may generate, based at least in part on the selected one or more screenshots, one or more query attributes to be used for one or more web resource requests for travel data. The data processing system may transmit the one or more requests for travel data to travel service provider system(s) and/or databases (e.g., historical databases comprising historical search queries and/or historical search results, etc., cached travel databases comprising cached travel data, and the like) that satisfy the one or more query attributes. In some examples, the data processing system 106 may present a loading user interface including the selected screenshot, as illustrated in the user interface 200D in FIG. 2D.

FIG. 2E illustrates a primary itinerary recommendation 212. That is, the data processing system may transmit the primary itinerary recommendation to the client device for presentation via a user interface 200E. The primary itinerary recommendation may comprise a first set of one or more itineraries that satisfy the one or more query attributes. In the particular example, the primary itinerary recommendation is associated with a single itinerary. The primary itinerary recommendation may be generated based at least in part on the data processing system receiving a first portion of travel data. The user interface 200E may present an indication 214 that a search for alternative travel options (e.g., secondary itinerary recommendation) is being performed.

FIG. 2F illustrates the primary itinerary recommendation 212 and a secondary itinerary recommendation 222. That is, the data processing system may transmit the primary itinerary recommendation and the secondary itinerary recommendation to the client device for presentation via a user interface 200F. In some examples, in response to receiving a second portion of travel data, the data processing system may update the primary itinerary recommendation. That is, an itinerary having a better price, layover time, flight duration, departure and/or arrival time, airline provider, etc. may be presented as a recommended itinerary.

Though only two itineraries are illustrated in FIG. 2F, a user may scroll down to view additional itinerary recommendations. Itinerary recommendations may be organized and/or ranked based at least in part on price, travel time (e.g., duration of individual flights and/or a total flight time), layover duration and/or location, departure and/or arrival times, airline providers, cabin class, backage allowance, in-flight amenities (e.g., entertainment system, Wi-Fi, meal options, seat features, etc.), seat selection options e.g., window seat, extra legroom seats), total trip cost (e.g., ranking may be based on additional costs, such as cost of extra fees), user reviews and ratings, refund policies, airport convenience (e.g., proximity of airport to the user), and the like.

In some examples, the user interface 200E may present a selectable option that, when selected, causes a price alert 216 to be generated for a particular itinerary. In some examples, based at least in part on receiving the first portion of travel data and the second portion of travel data, the data processing system may generate a purchase recommendation 218 for one or more itineraries. For example, the data processing system may recommend a user purchase a plane ticket at this time (or travel package, book a hotel, rent a vehicle, etc.), wait to purchase and/or recommend signing up for a price alert, or recommend the user book with a different provider for a better result (e.g., better price, better flight times, etc.). In the example illustrated in FIG. 2F, the user interface 200F presents a “BUY” purchase recommendation 218. In some examples, in response to receiving a selection of a control associated with the purchase recommendation, the data processing system may cause the user interface to present at least one of a first option to purchase one or more plane tickets associated with the itinerary, or a second option to sign up for a price alert for the one or more plane tickets. In the case where a user is interested in purchasing plane tickets, booking a hotel, renting a vehicle etc., the user may be navigated to an interface for booking the flight, hotel, etc. In some examples, the data processing system may perform a price check on an itinerary to confirm a presented itinerary (or recommended itinerary) is available for purchase. For example, the data processing system may send a request to a service provide system to check a real-time availability of an itinerary and booking status of the presented itinerary.

In some examples, to view additional flight options or other travel data, a user may select a “see all flights” selectable control 224. In some examples, receiving a selection of the “see all flights” selectable control 224 may cause the data processing system to reinitiate a search for additional results for travel data satisfying the one or more query attributes and/or reinitiate the receival of travel data from travel service provider system(s).

In some examples, individual itineraries may be associated with one or more comparison indicators 226 that indicate how individual itineraries compare with one another. Comparison indicators (or comparison recommendations) may include a “cheapest indicator,” such as the comparison indicator 226 illustrated in FIG. 2, representing the most affordable itinerary as compared to the rest of the itineraries presented on the user interface. Comparison indicators may include additional indicators such as a “shortest travel time” indicator, “longest travel time” indicator, “shortest layover” indicator, “redeye flight” indicator, “seat indicator” (e.g., window seat, aisle seat, emergency exit row, etc.) indicator, “preferred airline” indicator (e.g., based on a user preference and/or customer reviews), and the like. In some examples, comparison indicators may be based at least in part on user preferences. That is, a user may select (e.g., from a list of available comparison indicators), which indicators the user is interested in viewing in conjunction with travel data, such as a flight. For instance, a user that prefers redeye flights may select the option to be presented with “redeye flight” indicators, but not a “seat indicator” if that is not important to the user. This enables the data processing system to provide itineraries and/or other travel data is customized to the preferences of a user(s).

FIG. 3 illustrates a sequence diagram of an example process 300 for generating search results for travel data (e.g., itineraries, hotel options, car rentals, etc.) using image data. The operations described with respect to FIG. 3 may be performed in the order shown in FIG. 3 and/or in any other order. Additionally, at least some of the operations may be performed in parallel. Further, in some examples, not all of the operations may be performed, or additional operations may be performed as discussed throughout this disclosure.

In this example, FIG. 3 may include one or more components which may receive, analyze, and/or send data. Such components may include a client device 302, a data processing system 304, an Optical Character Recognition (OCR) system 306, an Artificial Intelligence (AI) system 308, and/or a travel service provider system(s) 310. In some examples, the data processing system 304 may include the OCR system 306 and/or the AI system 308.

At block 312, a client device 302 may submit (or upload) image data to a data processing system 304. The image data may comprise one or more screenshot(s) that were captured on a mobile device, a downloaded image, an image shared on a social media platform, a snippet or screenshot of an image captured on a desktop computer, laptop, tablet, etc. In some examples, the image may be a screenshot of an itinerary. Alternatively, or in addition to the screenshot, a user may submit a screenshot of a popular destination or may include a famous landmark, such as the Eiffel tower, Colosseum, Lincoln Memorial, and the like.

In some examples, the data processing system 304 may process the received image data. For example, an image processing component associated with data processing system 304 may validate and/or sanitize metadata associated with the image to ensure it is not a potential injection attack (or other type of cybersecurity attack in which malicious code or unauthorized commands may be inserted). For example, the image processing component may validate and/or sanitize metadata associated with the image data to ensure the image data does not contain malicious code and/or unexpected input. In some examples, the image processing component may verify that the uploaded image data is associated with the expected content type (e.g., image/jpeg, image/png) and/or it is in a proper format (e.g., JPEG, PNG, etc.). In some examples, the image processing component may automatically reject any image data that does not meet this criteria. In some examples, the image processing component 112 may enforce a size limit of the image data to prevent excessively large or resource-intensive images from being processed.

In some examples, the data processing system 304 may perform a preprocessing technique on the image data to enhance the quality of the image and prepare it for OCR. Preprocessing techniques may include correcting any rotation, tilts, or skews in the image, removing unnecessary borders or margins, filtering out background noise or artifacts, converting the image to black and image (i.e., grayscale), resizing the image, and the like. In some examples, the data processing system may determine a text layout associated with the image data (e.g., the positioning and placement of information in a screenshot of an itinerary).

At block 314, the data processing system 304 may send a request (i.e., a first request) to an OCR system 304 to perform OCR on the processed image data. In some examples, the OCR system 304 may be a third-party OCR system separate from the data processing system 304. In some examples, the OCR system 304 may be a cloud-based OCR system (e.g., a Google™ Cloud Vision API, Amazon™ Web Services (AWS), Microsoft Azure™, IBM Watson™, etc.), an open-source OCR library (e.g., Tesseract OCR™, GOCR, OCRopus, etc.), and the like. In some examples, in the case where an error occurs due to a request quota being exceeded (i.e., the data processing system exceeds the allowed quota for API requests to a third-party OCR system), or a rate limit error occurs due to the data processing system 304 exceeding a rate limit, the data processing system 304 may resend the request and/or throttle the rate of API requests to stay within a rate limit.

The OCR system 306 may extract text from the image data and convert it into a machine-readable form. In some examples, in the case where characters are not separated clearly, a character segmentation technique may be performed to divide text into distinct characters for recognition. In some examples, feature extraction may be performed on the image data to identity shape, spatial relationships, etc. In some examples, machine learning techniques (e.g., machine learning models, neural networks, pattern recognition techniques, large language models, and the like) may be used to identify characters in the image.

At block 316, in response to the first request, the data processing system 306 may receive a response comprising text associated with the image data.

At block 318, the data processing system may apply postprocessing techniques to the received OCR response. For example, the data processing system 304 may correct error(s) and/or improve accuracy of the recognized text (e.g., by spellchecking the recognized text, correcting grammatical errors in the recognized text, and the like). In some examples, the data processing system 304 may reformat the text to correspond to the text layout associated with the image data. In some examples, based at least in part on the OCR response, the data processing system 306 may determine that the image data is not associated with a flight itinerary and transmit instructions to the client device 302 to upload (or reupload) an image of an itinerary.

At block 320, the data processing system 304 may transmit a request (i.e., a second request) to an AI system 308 to generate one or more query attributes. In some examples, the second request may comprise making an API call to an AI system 308. An AI system may include, for example, a large language model system such as OpenAI ChatGPT™, BERT™, Text-to-Text (T5) Transformer™, XLNet™, and the like. The second request may comprise an instruction to generate the one or more query attributes using the processed OCR response. In some examples, the instruction may include a prompt (e.g., an instruction to generate a particular response) to format the text in a structured data format (e.g., JSON format, Extensive Markup Language (XML), Concise Binary Object Representation (CBOR), and the like). A structured data format may be associated with attribute-value pairs, such as “departure date”: “Jan. 13, 2024”, “departure city”: “Seattle”, etc. In some examples, the prompt may be stored as a property in the data processing system 304 so that it may be modified as needed. In some examples, the prompt may instruct the AI system 306 to limit an output length of the AI system response. In some examples, the second request may include an instruction to limit a length of the structured data format of the one or more query attributes.

At block 322, the data processing system 304 may receive a response from the AI system. The response may comprise one or more query attributes in a structured data format (e.g., JSON format).

At block 324, the data processing system 304 may validate and post-process the AI response. For example, the data processing system may detect and correct errors found in the response from the AI system 308 (e.g., by using Innovata™). In some examples, the data processing system may compare the image data with a response received from the AI system 308 (e.g., to validate a flight number, date, etc. associated with the provided image data).

At block 326, the data processing system 304 transmits one or more requests to travel service provider system(s) 310 for travel data that satisfy one or more query attributes. In some examples, transmitting one or more requests for travel data can comprise making calls to APIs associated with travel service provider system(s) 310. Individual travel service provider system(s) 310 process the received requests and return one or more responses with travel data that satisfies the query. In some examples, the travel data may be “live travel data” that represents current, real time, or near real time information for a travel related product or service. In some examples, the data processing system 106 may query a schedule of travel reservations, such as those provided by Innovata™ or Cirium™, based on the query attributes or other criteria included in the query. In some examples, in addition to, or alternative to sending one or more requests to travel service provider system(s) 310, the data processing system 106 may send a query to a database for cached travel data.

At block 328, the data processing system 304 receives, in response to the one or more requests and at a first time, a first portion of travel data that satisfy the one or more query attributes. The first portion of travel data may represent an initial set of responses received from the travel service provider system(s) 310. In some examples, the first portion of travel data may represent a first threshold number of responses that were received. In some examples, the threshold number of responses may depend on a quality or confidence score associated with the received response. In some examples, the first portion of travel data may be travel data that was received after a threshold period of time (e.g., 5 seconds, 7 seconds, etc.).

At block 330, the data processing system 304 may transmit the first portion of travel data to the computing device 302 for presentation via a user interface. That is, while responses to others of the one or more requests for travel data are still being received, the first portion of travel data may be transmitted for presentation. The first portion of travel data may comprise a first number (or first set) of one or more itineraries that satisfy the one or more query attributes. The first portion of travel data may be presented using any variety of graphical and/or textual representations (e.g., via a browser or dedicated application).

At block 332, the data processing system 304 receives, in response to the one or more requests and at a second time after the first time, a second portion of travel data that satisfy the one or more query attributes. The second portion of travel data may represent a second set of responses (or results) received from the travel service provider system(s) 310 that satisfy one or more query attributes. In some examples, the second portion of travel data may associated with a threshold number of responses that were received. In some examples, the second portion of travel data may be travel data that was received after a threshold period of time. In some examples, the data processing system 304 may determine that a threshold period of time (e.g., 15 seconds, 20 seconds, etc.) has passed since transmitting the one or more requests for travel data. In response to determining that the threshold period of time has passed, the data processing system 304 may cause a server associated with the data processing system 304 to stop receiving travel data responses from the travel service provider system(s) 310.

At block 334, the data processing system 304 may transmit the second portion of travel data to the computing device 302 for presentation via the user interface. In some examples, the first portion of travel data may be updated based at least in part on the second portion of travel data. In some examples, the data processing system 304 may present the first portion of travel data and/or the second portion of travel data in a ranked and/or ordered manner (e.g., according to user preference data stored in association with the user account).

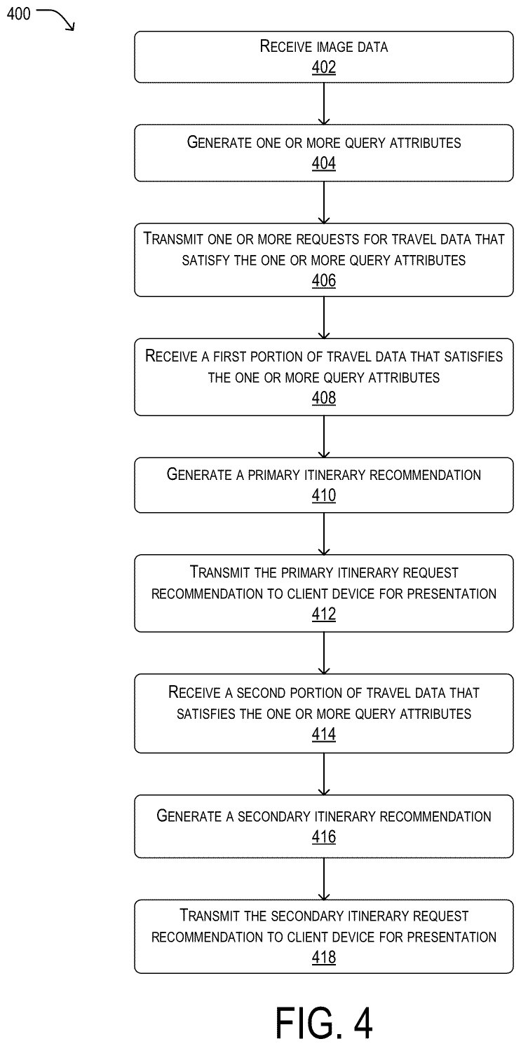

FIG. 4 is a flow diagram of an example process 400 for generating itinerary recommendation(s) based in part on receiving a screenshot of an itinerary, in accordance with examples of the present disclosure. The process described herein is illustrated as a collection of block in a logical flow diagram, which represents a sequence of operations, some or all of which may be implemented in hardware, software or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation, unless specifically noted. Any number of the described blocks may be combined in any order and/or in parallel to implement the process, or alternative processes, and not all of the blocks may be executed. For discussion purposes, the process is described with reference to the environments, architectures and systems described in the examples herein, such as, for example those described with respect to FIGS. 1-3, 5, and 6, although the processes may be implemented in a wide variety of other environments, architectures and systems.

At block 402, the process 400 may include receiving, from a computing device, a request to perform a query (or travel search). In some examples, the query request (or search request) may comprise image data. The image data may be a screenshot captured on a mobile device, a downloaded image, an image shared on a social media platform, a snippet or screenshot of an image captured on a desktop computer, laptop, tablet, etc. In some examples, a user may copy and paste an image or drag-and-drop an image into an interactive box associated with the data processing system. The image may be in a JPEG format, PNG format, GIF format, etc. In some examples, the image may be a screenshot of an itinerary. The itinerary may include textual information about a travel destination and may include details such as travel dates, flight or transportation information, hotel reservations, and/or any other relevant travel data. In some examples, the image may be of a popular destination and/or may include a famous landmark, such as the Eiffel tower, Colosseum, Lincoln Memorial, etc. In some examples, the query request may comprise multiple images. That is, a user may upload multiple images to provide additional context and/or in order to receive a more personalized search result.

At block 404, the process 400 may include generating, from the image data, one or more query attributes. For example, to generate one or more query attributes, an image processing component may perform OCR on the image to extract text and convert it into a machine-readable form. In some examples, prior to performing OCR, the image processing component may perform a preprocessing technique on the image data to enhance the quality of the image and prepare it for OCR. In some examples, machine learning techniques (e.g., machine learning models, neural networks, pattern recognition techniques, large language models, and the like) may be used to identify characters in the image. In some examples, after performing OCR, the image processing component may correct error(s) and/or improve accuracy of the recognized text (e.g., by spellchecking the recognized text, correcting grammatical errors in the recognized text, and the like). Further details related to generating one or more query attributes are provided above in the description of FIG. 1-3.

At block 406, the process 400 may include transmitting one or more requests for travel data that satisfy one or more query attributes. The data processing system may use the generated query attributes and their associated values to generate one or more requests for travel data. In some examples, transmitting one or more requests for travel data can be a call to APIs associated with travel service provider system(s). Individual travel service provider systems process the received requests and return one or more responses with travel data that satisfies the query. In some examples, the data processing system may query a schedule of travel reservations, such as those provided by Innovata™ or Cirium™, based on the query attributes or other criteria included in the query.

At block 408, the process may include receiving, in response to the one or more requests and at a first time, a first portion of travel data that satisfy the one or more query attributes. The first portion of travel data may represent an initial set of responses received from the travel service provider system(s). In some examples, the first portion of travel data may represent a first threshold number of responses that were received. In some examples, the threshold number of responses may depend on a quality of confidence score associated with the received response. In some examples, the first portion of travel data may be travel data that was received after a threshold period of time (e.g., 5 seconds, 7 seconds, etc.).

At block 410, the process 400 may include generating a primary itinerary recommendation based at least in part on receiving the first portion of travel data. The primary itinerary recommendation may comprise a first set of one or more itineraries that satisfy the one or more query attributes. In some examples, the primary itinerary recommendation may comprise one or more itineraries that satisfy a greater number of query attributes (as compared to the secondary itinerary recommendations). In at least one example, the primary itinerary recommendation may comprise a single itinerary that represents an itinerary the user may be most interested in purchasing.

At block 412, the process 400 may include transmitting the primary itinerary recommendation to the computing device for presentation via a user interface. That is, while responses to others of the one or more requests for travel data are still being received, the primary itinerary recommendation may be transmitted for presentation. The primary itinerary recommendation may be presented using any variety of graphical and/or textual representations (e.g., via a browser or dedicated application).

At block 414, the process 400 may include receiving, in response to the one or more requests and at a second time after the first time, a second portion of travel data that satisfy the one or more query attributes. The second portion of travel data may represent a second set of responses (or results) received from the travel service provider system(s). In some examples, the second portion of travel data may represent a threshold number of responses that were received. In some examples, the threshold number of responses may depend on a quality or confidence score associated with the received response. In some examples, the second portion of travel data may be travel data that was received after a threshold period of time. In some examples, the data processing system may determine that a threshold period of time (e.g., 10 seconds, 15 seconds, 20 seconds, etc.) has passed since transmitting the one or more requests for travel data. In response to determining that the threshold period of time has passed, the data processing system may cause a server associated with the data processing system to stop receiving travel data responses from the travel service provider system(s).

At block 416, the process 400 may include generating a secondary itinerary recommendation different than the primary itinerary recommendation based in part on the received second portion of travel data. In some examples, the secondary itinerary recommendation may comprise alternative itinerary options. The secondary itinerary recommendation may comprise a second set of one or more itineraries that satisfy the one or more query attributes. In some examples, the secondary itinerary recommendation may include one or more itineraries that satisfy a second number of one or more query attributes. In some examples, the second itinerary recommendation may comprise one or itineraries that satisfy a different number of query attributes and/or a lesser number of query attributes as compared to one or more itineraries in the primary itinerary recommendation

At block 418, the process 400 may include transmitting the secondary itinerary recommendation to the computing device for presentation via the user interface. The secondary itinerary recommendation may be presented using any variety of graphical and/or textual representations. The itineraries may be actionable such that selection of a result (or a user interface element associated with a result) navigates the user to an interface for booking the flight with the provider. In some examples, the primary recommendation may be updated based at least in part in the secondary recommendation.

Additionally, or alternatively, the process 400 may include transmitting, over a network, a first request to perform optical character recognition (OCR) on the image data, the image data associated with a text layout. The process 400 may also include receiving, in response to the first request, text associated with the image data and reformatting the text data to correspond to the text layout associated with the image data. The process 400 may also include transmitting, over the network, a second request to generate the one or more query attributes in a structured data format using the text data. The process 400 may also include receiving, in response to the second request, the one or more query attributes in the structured data format. In some examples, the second request includes an instruction to limit a length of the structured data format of the one or more query attributes.

Additionally, or alternatively, the process 400 may include generating the one or more query attributes from the image data based at least in part by inputting the image data into a machine learning model configured to receive the image data as input and generate the one or more query attributes in a structured data format as output.

Additionally, or alternatively, the process 400 may include weighting the one or more query attributes based at least in part on a preference associated with a user profile of the client device. In some examples, generating the primary itinerary recommendation and the secondary itinerary recommendation is based at least in part on the weighting.

Additionally, or alternatively, the process 400 may include generating, based at least in part on receiving the first portion of travel data and the second portion of travel data, a purchase recommendation for an itinerary, the purchase recommendation associated with a control. The process 400 may also include receiving a selection of the control. In response to receiving the selection of the control, the data processing system may cause the user interface to present at least one of: a first option to purchase one or more plane tickets associated with the itinerary, or a second option to sign up for a price alert for one or more plane tickets.

Additionally, or alternatively, the process 400 may include determining a threshold period of time has passed since transmitting the one or more requests for the travel data. The process 400 may also include causing the server to stop receiving travel data based at least in part on determining the threshold period of time has passed.

Additionally, or alternatively, the process 400 may include receiving, from the client device, second image data representing a second screenshot of a landmark. The process 400 may also include generating, based at least in part on the second image data, a second set of one or more query attributes to be used for a second number of one or more web resource requests for second travel data. The process 400 may also include transmitting, by the server, a second number of one or more requests for the second travel data that satisfies the second set of one or more query attributes. The process 400 may also include receiving, in response to the second number of one or more requests, the second travel data. The process 400 may also include generating, based at least in part on receiving the second travel data, a third set of one or more itineraries that satisfy the second set of one or more query attributes. The process 400 may also include transmitting the third set of one or more itineraries to the client device for presentation via the user interface.

Additionally, or alternatively, the process 400 may include receiving, from the client device and in addition to the image data, one or more search criteria for a travel reservation. In some examples, generating the primary itinerary recommendation and the secondary itinerary recommendation is based at least in part on the one or more search criteria.

FIG. 5 is a flow diagram of an example process 500 for the generation and training of artificial intelligence models to perform one or more of the processes described herein. The process described herein is illustrated as a collection of block in a logical flow diagram, which represents a sequence of operations, some or all of which may be implemented in hardware, software or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation, unless specifically noted. Any number of the described blocks may be combined in any order and/or in parallel to implement the process, or alternative processes, and not all of the blocks may be executed. For discussion purposes, the process is described with reference to the environments, architectures and systems described in the examples herein, such as, for example those described with respect to FIGS. 1-4 and 6, although the processes may be implemented in a wide variety of other environments, architectures and systems.

FIG. 5 is a flow diagram of an example process 500 for the generation and training of artificial intelligence models to perform one or more of the processes described herein. The order in which the operations or steps are described is not intended to be construed as a limitation, and any number of the described operations may be combined in any order and/or in parallel to implement process 500.

At block 502, the process 500 may include generating one or more artificial intelligence models. For example, the artificial intelligence models may utilize predictive analytic techniques, which may include, for example, predictive modeling, artificial intelligence, and/or data mining. Generally, predictive modeling may utilize statistics to predict outcomes. Artificial intelligence, while also utilizing statistical techniques, may provide the ability to improve outcome prediction performance without being explicitly programmed to do so. A number of artificial intelligence techniques may be employed to generate and/or modify the layers and/or models described herein. Those techniques may include, for example, decision tree learning, association rule learning, artificial neural networks (including, in examples, deep learning), inductive logic programming, support vector machines, clustering, Bayesian networks, reinforcement learning, representation learning, similarity and metric learning, sparse dictionary learning, and/or rules-based artificial intelligence.

Information from stored and/or accessible data may be extracted from one or more databases, such as the datastore(s) 620, and may be utilized to predict trends and behavior patterns. The predictive analytic techniques may be utilized to determine associations and/or relationships between explanatory variables and predicted variables from past occurrences and utilizing these variables to predict the unknown outcome. The predictive analytic techniques may include defining the outcome and data sets used to predict the outcome.

Data analysis may include using one or more models, including for example one or more algorithms, to inspect the data with the goal of identifying useful information and arriving at one or more determinations that assist in predicting the outcome of interest. One or more validation operations may be performed, such as using statistical analysis techniques, to validate accuracy of the models. Thereafter predictive modeling may be performed to generate accurate predictive models.

At block 504, the process 500 may include collecting feedback data over a period of time. The feedback data may include any of the data described with respect to the datastore(s) 620, any data associated with image processing of an itinerary, travel destination, or any other data described with respect to FIGS. 1-4. This information may include, for example, user travel preferences (e.g., seat preferences, meal preferences, travel departure time/arrival time preferences), booking history (e.g., records of past flights, hotels, car rental bookings made through the data processing system), user search history (e.g., details of previous flight and travel searches performed by user(s)), saved searches and price alerts (e.g., user configured saved search and price alerts for particular travel itineraries, screenshot searches, or destinations), and the like. This information may include other historical data associated with users, feedback data and/or training data, testing datasets, etc.

At block 506, the process 500 may include generating a training dataset from the feedback data. Generation of the training dataset may include formatting the feedback data into input vectors for the artificial intelligence model to intake, as well as associating the various data with the outcomes of the transactions described herein.

At block 508, the process 500 may include generating one or more trained artificial intelligence models utilizing the training dataset. Generation of the trained artificial intelligence models may include updating parameters and/or weightings and/or thresholds utilized by the models to determine weighting of query attributes, to predict travel data, to rank itineraries, to determine personalized itinerary recommendations, and the like. For example, an artificial intelligence model may be generated and configured to determine which itineraries to present to users (e.g., based at least in part on user preferences, received search results, etc.), to determine ranking of itineraries, and the like. During artificial intelligence model training, the data described above may serve to adjust weights and thresholds that the model utilizes to determine which itineraries to present to a user, which itineraries a user may be interested in purchasing, whether to recommend a user purchase an itinerary now or sign up for price alerts and wait for a better deal. The output of these trained artificial intelligence models may be more accurate and may be configured to more readily determine whether a user will be interested in booking a flight, hotel reservation, etc.

At block 510, the process 500 may include determining whether the trained artificial intelligence models indicate improved performance metrics. For example, a testing group may be generated where the outcomes of given transactions are known but not to the trained artificial intelligence models. The trained artificial intelligence models may generate results, which may be compared to the known results to determine whether the results of the trained artificial intelligence model produce a superior result than the results of the artificial intelligence model prior to training.

In examples where the trained artificial intelligence models indicate improved performance metrics, the process 500 may include, at block 512, utilizing the trained artificial intelligence models for generating subsequent results. For example, the trained artificial intelligence models may be utilized to determine weighting of query attributes, to predict travel data, to rank itineraries or other travel data, to determine personalized itinerary recommendations, and the like. It should be understood that the trained artificial intelligence models may be utilized in any scenario where models are utilized as described herein.

In examples where the trained artificial intelligence models do not indicate improved performance metrics, the process 500 may include, at block 514, utilizing the previous iteration of the artificial intelligence models for generating subsequent results.

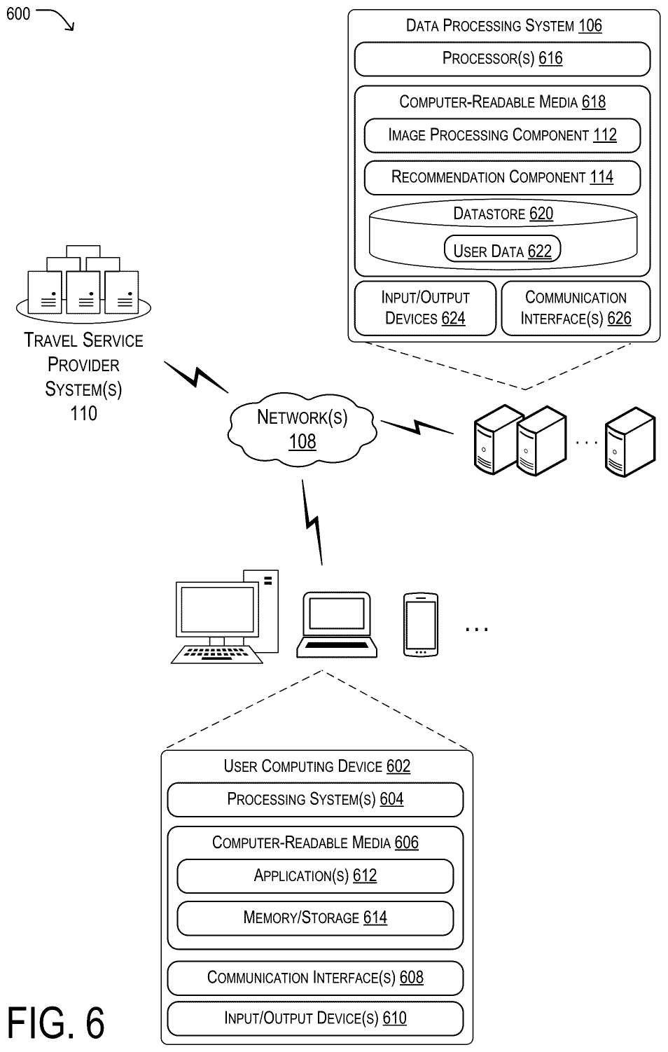

FIG. 6 illustrates an example system 600 that includes an example computing device 602 that is representative of one or more computing systems and/or devices that may implement the various techniques described herein. Data processing system 106 and the user computing device 602 can transmit, receive, and/or store data (e.g., travel data, itineraries, image data, etc.) using the network(s) 108, as described herein. In some examples, the computing device 602 may be a server of a service provider, a device associated with a client (e.g., a client device), an on-chip system, and/or any other suitable computing device or computing system.

The example computing device 602 as illustrated includes a processing system 604, one or more computer-readable media 606 (including application(s) 612 and memory/storage component 614), communication interface(s) 608, and one or more input/output device(s) 610 that are communicatively coupled, one to another. Although not shown, the computing device 602 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 604 is representative of functionality to perform one or more operations using hardware. The processing system 604 can include hardware elements that may be configured as processors, functional blocks, and so forth. This may include implementation in hardware as an application specific integrated circuit or other logic device formed using one or more semiconductors. The hardware elements are not limited by the materials from which they are formed, or the processing mechanisms employed therein. For example, processors may be comprised of semiconductor(s) and/or transistors (e.g., electronic integrated circuits (ICs)). In such a context, processor-executable instructions may be electronically executable instructions.

The computer-readable media 606 is illustrated as including application(s) 612 and memory/storage component 614. Application 612 can include a mobile application, a web application, a desktop application, which can be provided by the data processing system. In some examples, the application 612 may be downloaded from an application store, accessible via the Internet, or otherwise executable by the processor(s) to perform operations as described herein. The application 612 may be an access point, enabling the user computing device 602 to interact with servers and the data processing system 106. The application 612 may facilitate the exchange of data between and among various other user computing devices. In some examples, the application 612 may present user interfaces, as described herein. A user can interact with the user interfaces via touch input, keyboard input, mouse input, voice commands, or any other type of input.

The memory/storage component 614 represents memory/storage capacity associated with one or more computer-readable media. The memory/storage component 614 may include volatile media (such as random-access memory (RAM)) and/or nonvolatile media (such as read only memory (ROM), Flash memory, optical disks, magnetic disks, and so forth). The memory/storage component 614 may include fixed media (e.g., RAM, ROM, a fixed hard drive, and so on) as well as removable media (e.g., Flash memory, a removable hard drive, an optical disc, and so forth). The computer-readable media 606 may be configured in a variety of other ways as further described below.

Communication interface(s) 608 can include or more interfaces and hardware components for enabling communication with various other devices and system (e.g., data processing system 106), such as over the network(s) 108 or directly. In some examples, the communication interface(s) 608, can facilitate communication via Web Sockets, APIs (e.g., using API calls), HTTPs, and the like.

Input/output interface(s) 608 are representative of functionality to allow a user to enter commands and information to computing device 602, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 602 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” “logic,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on and/or transmitted across some form of computer-readable media. The computer-readable media may include a variety of media that may be accessed by the computing device 602. By way of example, and not limitation, computer-readable media may include “computer-readable storage media” and “computer-readable transmission media.” “Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer-readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable transmission media” may refer to a medium that is configured to transmit instructions to the hardware of the computing device 602, such as via a network 108. Computer-readable transmission media typically may transmit computer-readable instructions, data structures, program modules, or other data in a modulated data signal, such as carrier waves, data signals, or other transport mechanism. Computer-readable transmission media also include any information delivery media. The term “modulated data signal” means a signal that has one or more of its characteristics set or changed in such a manner as to encode information in the signal. By way of example, and not limitation, computer-readable transmission media include wired media such as a wired network or direct-wired connection, and wireless media such as acoustic, radio frequency (RF), infrared, and other wireless media.

As previously described, hardware elements and computer-readable media 606 are representative of modules, programmable device logic and/or device logic implemented in a hardware form that may be employed in some examples to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements. The computing device 602 may be configured to implement particular instructions and/or functions corresponding to the software and/or hardware modules. Accordingly, implementation of a module that is executable by the computing device 602 as software may be achieved at least partially in hardware, e.g., through use of computer-readable storage media and/or hardware elements of the processing system 604. The instructions and/or functions may be executable/operable by one or more articles of manufacture (for example, one or more computing devices 602 and/or processing systems 604) to implement techniques, modules, and examples described herein.

The techniques described herein may be supported by various configurations of the computing device 602 and are not limited to the specific examples of the techniques described herein. This functionality may also be implemented all or in part through use of a distributed system, such as over a network or “cloud” via a platform. The cloud includes and/or is representative of a platform for resources. The platform abstracts underlying functionality of hardware (e.g., servers) and software resources of the cloud. The resources may include applications and/or data that can be utilized while computer processing is executed on servers that are remote from the computing device 602. Resources can also include services provided over the Internet and/or through a subscriber network, such as a cellular or Wi-Fi network.

In at least one example, the data processing system 106 can include processor(s) 616, computer-readable media 618 (which includes an image processing component 112 and a recommendation component 114), a datastore 620 (which can include stored user data 622), input/output devices 624, and/or communication interface(s) 626.

The processor(s) 616 can be a single processing unit or multiple processing units, and can include a single or multiple units or multiple processing cores. The processor(s) 616 can comprise any of the types of processors described above with reference to the processing system(s) 604.

The computer-readable media 618 can comprise any of the types of computer-readable media described above with reference to the computer-readable media 606 and may be the same as or different than the computer-readable media 606. Functional components stored in the computer-readable media can optionally include at least one application or an operating system. The image processing component 112 and the recommendation component 114 are described above in relation to FIG. 1.

The datastore 620 can be configured to store data that is accessible, updatable, manageable, etc. In some examples, the datastore 620 can be integrated with the data processing system. In some examples, the datastore 620 may be located remote from the data processing system and can be accessible to the data processing system and/or user devices, such as user computing device 602. The datastore 620 can comprise multiple databases, which can include user data 622. Additional or alternative data may be stored in the datastore 620 and/or other datastores associated with the data processing system.

The user data 622 stored in the datastore 620 can include user profile data (or user account data), which can store data associated with a user. User data 622 may include, for example, a user ID or username, email address, contact information (e.g., address), frequent flyer or loyalty program details, travel preferences (e.g., seat preferences, meal preferences, travel departure time/arrival time preferences), booking history (e.g., records of past flights, hotels, car rental bookings made through the data processing system), user search history (e.g., details of previous flight and travel searches performed by the user), saved searches and price alerts (e.g., user configured saved search and price alerts for particular travel itineraries, screenshot searches, or destinations), payment information (e.g., credit card information), cookies or other tracking data, and the like.

The input/output devices 624 can include display, various user interface controls, audio speakers, connection ports, or other input/output devices such as described above with reference to input/output devices 610. The communication interface(s) 626 can include one or more interfaces and hardware components for enabling communication with various devices (e.g., the user computing device 602), such as over the network 108, or directly, as described above with reference to communication interface(s) 608.

### CONCLUSION

Although the discussion above sets forth example implementations of the described techniques, other architectures may be used to implement the described functionality, and are intended to be within the scope of this disclosure. Furthermore, although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method, comprising:
receiving, from a client device, image data representing a screenshot of an itinerary;
generating, from the image data and based at least in part on an indication that the image data is to be used for identifying itinerary recommendations, one or more query attributes to be used for one or more web resource requests for travel data;
transmitting, by a server, one or more requests for the travel data that satisfy the one or more query attributes;
receiving, at a first time and in response to the one or more requests, a first portion of travel data that satisfies the one or more query attributes;
generating, based at least in part on receiving the first portion of travel data, a primary itinerary recommendation, the primary itinerary recommendation comprising a first set of one or more itineraries that satisfy the one or more query attributes;
transmitting the primary itinerary recommendation to the client device for presentation via a user interface;
receiving, at a second time after the first time and in response to the one or more requests, a second portion of travel data satisfying the one or more query attributes;
generating, based at least in part on receiving the second portion of travel data, a secondary itinerary recommendation, the secondary itinerary recommendation comprising a second set of one or more itineraries that satisfy the one or more query attributes, wherein the second set of one or more itineraries differs at least in part from the first set of one or more itineraries; and
transmitting the secondary itinerary recommendation to the client device for presentation via the user interface.

2. The method of claim 1, wherein generating the one or more query attributes from the image data comprises:
transmitting, over a network, a first request to perform optical character recognition (OCR) on the image data, the image data associated with a text layout;
receiving, in response to the first request, text data associated with the image data;
reformatting the text data to correspond to the text layout associated with the image data;
transmitting, over the network, a second request to generate the one or more query attributes in a structured data format using the text data; and
receiving, in response to the second request, the one or more query attributes in the structured data format.

3. The method of claim 2, wherein the second request includes an instruction to limit a length of the structured data format of the one or more query attributes.

4. The method of claim 1, wherein generating the one or more query attributes from the image data comprises inputting the image data into a machine learning model configured to receive the image data as input and generate the one or more query attributes in a structured data format as output.

5. The method of claim 1, wherein generating the primary itinerary recommendation and the secondary itinerary recommendation comprises inputting the first portion of travel data, the second portion of travel data, and user data into a machine learning model configured to receive the first portion of travel data, the second portion of travel data, and user data as input and generate the primary itinerary recommendation and the secondary itinerary recommendation as output.

6. The method of claim 1, further comprising:
weighting the one or more query attributes based at least in part on a preference associated with a user profile of the client device; and
wherein generating the primary itinerary recommendation and the secondary itinerary recommendation is based at least in part on the weighting.

7. The method of claim 1, further comprising:
generating, based at least in part on receiving the first portion of travel data and the second portion of travel data, a purchase recommendation for an itinerary, the purchase recommendation associated with a control;
receiving a selection of the control; and
in response to receiving the selection of the control, causing the user interface to present at least one of:
a first option to purchase one or more plane tickets associated with the itinerary; or
a second option to sign up for a price alert for one or more plane tickets.

8. The method of claim 1, further comprising:
determining a threshold period of time has passed since transmitting the one or more requests for the travel data; and
causing the server to stop receiving travel data based at least in part on determining the threshold period of time has passed.

9. The method of claim 1, further comprising:
receiving, from the client device, second image data representing a second screenshot of a landmark;
generating, based at least in part on the second image data, a second set of one or more query attributes to be used for a second number of one or more web resource requests for second travel data;
transmitting, by the server, a second number of one or more requests for the second travel data that satisfies the second set of one or more query attributes;
receiving, in response to the second number of one or more requests, the second travel data;
generating, based at least in part on receiving the second travel data, a third set of one or more itineraries that satisfy the second set of one or more query attributes; and
transmitting the third set of one or more itineraries to the client device for presentation via the user interface.

10. The method of claim 1, further comprising:
receiving, from the client device and in addition to the image data, one or more search criteria for a travel reservation; and
wherein generating the primary itinerary recommendation and the secondary itinerary recommendation is based at least in part on the one or more search criteria.

11. A system comprising:
one or more processors; and
one or more non-transitory computer-readable media storing instructions that, when executed, cause the system to:
receive, from a client device, image data representing a screenshot of an itinerary;
generate, from the image data and based at least in part on an indication that the image data is to be used for identifying itinerary recommendations, one or more query attributes to be used for one or more web resource requests for travel data;
transmit one or more requests for the travel data that satisfy the one or more query attributes;
receive, at a first time and in response to the one or more requests, a first portion of travel data that satisfies the one or more query attributes;
generate, based at least in part on receiving the first portion of travel data, a primary itinerary recommendation, the primary itinerary recommendation comprising a first set of one or more itineraries that satisfy the one or more query attributes;
transmit the primary itinerary recommendation to the client device for presentation via a user interface;
receive, at a second time after the first time and in response to the one or more requests, a second portion of travel data satisfying the one or more query attributes;
generate, based at least in part on receiving the second portion of travel data, a secondary itinerary recommendation, the secondary itinerary recommendation comprising a second set of one or more itineraries that satisfy the one or more query attributes, wherein the second set of one or more itineraries differs at least in part from the first set of one or more itineraries; and
transmit the secondary itinerary recommendation to the client device for presentation via the user interface.

12. The system of claim 11, wherein generating the one or more query attributes from the image data further cause the system to:
transmit, over a network, a first request to perform optical character recognition (OCR) on the image data, the image data associated with a text layout;
receive, in response to the first request, text data associated with the image data;
reformat the text data to correspond to the text layout associated with the image data;
transmit, over the network, a second request to generate the one or more query attributes in a structured data format using the text data; and
receive, in response to the second request, the one or more query attributes in the structured data format.

13. The system of claim 12, wherein the second request includes an instruction to limit a length of the structured data format of the one or more query attributes.

14. The system of claim 11, wherein generating the one or more query attributes from the image data comprises inputting the image data into a machine learning model configured to receive the image data as input and generate the one or more query attributes in a structured data format as output.

15. One or more non-transitory computer-readable media storing instructions that, when executed, cause one or more processors to:
receive, from a client device, image data representing a screenshot of an itinerary;
generate, from the image data and based at least in part on an indication that the image data is to be used for identifying itinerary recommendations, one or more query attributes to be used for one or more web resource requests for travel data;
transmit, by a server, one or more requests for the travel data that satisfy the one or more query attributes;
receive, at a first time and in response to the one or more requests, a first portion of travel data that satisfies the one or more query attributes;
generate, based at least in part on receiving the first portion of travel data, a primary itinerary recommendation, the primary itinerary recommendation comprising a first set of one or more itineraries that satisfy the one or more query attributes;
transmit the primary itinerary recommendation to the client device for presentation via a user interface;
receive, at a second time after the first time and in response to the one or more requests, a second portion of travel data satisfying the one or more query attributes;
generate, based at least in part on receiving the second portion of travel data, a secondary itinerary recommendation, the secondary itinerary recommendation comprising a second set of one or more itineraries that satisfy the one or more query attributes, wherein the second set of one or more itineraries differs at least in part from the first set of one or more itineraries; and
transmit the secondary itinerary recommendation to the client device for presentation via the user interface.

16. The one or more non-transitory computer-readable media of claim 15, wherein the instructions further cause the one or more processors to:
weight the one or more query attributes based at least in part on a preference associated with a user profile of the client device; and
wherein generating the primary itinerary recommendation and the secondary itinerary recommendation is based at least in part on the weighting.

17. The one or more non-transitory computer-readable media of claim 15, wherein the instructions further cause the one or more processors to:
generate, based at least in part on receiving the first portion of travel data and the second portion of travel data, a purchase recommendation for an itinerary, the purchase recommendation associated with a selectable control;
receiving a selection of the selectable control; and
in response to receiving the selection of the selectable control, causing the user interface to present at least one of:
a first option to purchase one or more plane tickets associated with the itinerary; or
a second option to sign up for a price alert for one or more plane tickets.

18. The one or more non-transitory computer-readable media of claim 15, wherein the instructions further cause the one or more processors to:
determine a threshold period of time has passed since transmitting the one or more requests for the travel data; and
cause the server to stop receiving travel data based at least in part on determining the threshold period of time has passed.

19. The one or more non-transitory computer-readable media of claim 15, wherein the instructions further cause the one or more processors to:
receive, from the client device, second image data representing a second screenshot of a landmark;
generate, based at least in part on the second image data, a second set of one or more query attributes to be used for a second number of one or more web resource requests for second travel data;
transmit, by the server, a second number of one or more requests for the second travel data that satisfies the second set of one or more query attributes;
receive, in response to the second number of one or more requests, the second travel data;
generate, based at least in part on receiving the second travel data, a third set of one or more itineraries that satisfy the second set of one or more query attributes; and
transmit the third set of one or more itineraries to the client device for presentation via the user interface.

20. The one or more non-transitory computer-readable media of claim 15, wherein the instructions further cause the one or more processors to:
receive, from the client device and in addition to the image data, one or more search criteria for a travel reservation; and
wherein generating the primary itinerary recommendation and the secondary itinerary recommendation is based at least in part on the one or more search criteria.
